(19) United States
(12) Patent Application Publication
(10) Pub. No.: US 2012/0137044 A1
(43) Pub. Date: May 31, 2012

(54) METHOD AND APPARATUS FOR PROVIDING PERSISTENT COMPUTATIONS

(75) Inventors: Sergey Boldyrev, Soderkulla (FI); Vesa-Veikko Luukkala, Espoo (FI); Jukka Honkola, Espoo (FI); Hannu Ensio Laine, Espoo (FI); Mika Juhani Mannermaa, Burlington, MA (US); Ian Justin Oliver, Soderkulla (FI); Ora Lassila, Hollis, NH (US)

(73) Assignee: Nokia Corporation, Espoo (FI)

(21) Appl. No.: 12/956,833

(22) Filed: Nov. 30, 2010

(51) Int. Cl. G06F 12/02

(52) U.S. Cl. 711/2; 711/E12.007

(57) ABSTRACT

An approach is provided for providing persistent computations. A persistent computation manager determines at least one non-volatile memory space of a device. The persistent computation manager also determines at least one other non-volatile memory space of at least one other device. The persistent computation manager further determines to form a persistent memory address space based, at least in part, on the at least one non-volatile memory space and the at least one other non-volatile memory space.

### BACKGROUND

Mobile devices with various methods of connectivity are now for many people becoming the primary gateway to the internet and also a major storage point for personal information. This is in addition to the normal range of personal computers and furthermore sensor devices plus internet based providers. Combining these devices together and lately the applications and the information stored by those applications is a major challenge of interoperability. This can be achieved through numerous, individual and personal information spaces in which persons, groups of persons, etc. can place, share, interact and manipulate webs of information with their own locally agreed semantics without necessarily conforming to an unobtainable, global whole.

Furthermore, in addition to information, the information spaces may be combined with webs of shared and interactive computations or computation spaces so that the devices having connectivity to the computation spaces can have the information in the information space manipulated within the computation space environment and the results delivered to the device, rather than the whole process being performed locally in the device. These combined information spaces and computation spaces often referred to as smart spaces, are extensions of the ‘Giant Global Graph’ in which one can apply semantics and reasoning at a local level.

In one embodiment, information and computation spaces are working spaces respectively embedded with distributed information and computation infrastructures spanned around computers, information appliances, processing devices and sensors that allow people to work efficiently through access to information and computations from computers or other devices. An information space or a computation space can be rendered by the computation devices physically presented as heterogeneous networks (wired and wireless). However, despite the fact that information and computation presented by the respective spaces can be distributed with different granularity, the distributed computations are constructed in the typically volatile run-time environments which require a maintained power supply. As a result, if the volatile memory is refreshed or the power supply is lost due to any incident, the constructed distributed computations are lost, even if the execution is not yet completed, and the whole process needs to be repeated after restoration of the power supply. This may cause loss of sensitive information, wasting of valuable resources, etc.

### SOME EXAMPLE EMBODIMENTS

Therefore, there is a need for an approach for providing persistent computations, to enable continued computations, even in conditions when the power source cannot be maintained (e.g. when the device requesting the computations is turned off).

According to one embodiment, a method comprises determining at least one non-volatile memory space of a device. The method also comprises determining at least one other non-volatile memory space of at least one other device. The method further comprises determining to form a persistent memory address space based, at least in part, on the at least one non-volatile memory space and the at least one other non-volatile memory space.

According to another embodiment, an apparatus comprises at least one processor, and at least one memory including computer program code, the at least one memory and the computer program code configured to, with the at least one processor, cause, at least in part, the apparatus to determine at least one non-volatile memory space of a device. The apparatus is also caused to determine at least one other non-volatile memory space of at least one other device. The apparatus is further caused to determine to form a persistent memory address space based, at least in part, on the at least one non-volatile memory space and the at least one other non-volatile memory space.

According to another embodiment, a computer-readable storage medium carries one or more sequences of one or more instructions which, when executed by one or more processors, cause, at least in part, an apparatus to determine at least one non-volatile memory space of a device. The apparatus is also caused to determine at least one other non-volatile memory space of at least one other device. The apparatus is further caused to determine to form a persistent memory address space based, at least in part, on the at least one non-volatile memory space and the at least one other non-volatile memory space.

According to another embodiment, an apparatus comprises means for determining at least one non-volatile memory space of a device. The apparatus also comprises means for determining at least one other non-volatile memory space of at least one other device. The apparatus further comprises means for determining to form a persistent memory address space based, at least in part, on the at least one non-volatile memory space and the at least one other non-volatile memory space.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing persistent computations, according to one embodiment;

FIG. 2 is a diagram of the components of persistent computation manager, according to one embodiment;

FIG. 3 is a flowchart of a process for providing persistent computations, according to one embodiment;

FIG. 4 is a diagram of relation between processes, computation closures and closure primitives, according to one embodiment;

FIG. 5 is a flowchart of a process for constructing a persistent memory address space, according to one embodiment;

FIG. 6 is a diagram of persistent memory address space among devices, according to one embodiment;

FIGS. 7A-7B are diagrams of computation closures recycling among devices, according to one embodiment;

FIG. 8 is a diagram of process migration from a device to another device, according to one embodiment

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing persistent computations are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “information space” or “smart space” refers to an aggregated information set from different sources. This multi-sourcing is very flexible since it accounts and relies on the observation that the same piece of information can come from different sources. For example, the same information (e.g., contact information for a particular contact) can appear in the same information space from multiple sources (e.g., a locally stored contacts database, a public directory, a work contact database, etc.). In one embodiment, information within the information space or smart space is represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information that is implemented in web resources; using a variety of syntax formats. Although various embodiments are described with respect to information spaces and RDF, it is contemplated that the approach described herein may be used with other structures and conceptual description methods used to create models of information.

As used herein, the term computation closure identifies a particular computation procedure together with relations and communications among various processes including passing arguments, sharing process results, flow of data and process results, etc. The computation closures (e.g., a granular reflective set of instructions, data, and/or related execution context or state) provide the capability of slicing of computations for processes and transmitting the computation slices between devices, infrastructures and information spaces.

As used herein, the term computation space refers to an aggregated set of computation closures from different sources. In one embodiment, computations within the computation space is represented using Semantic Web standards such as Resource Description Framework (RDF), RDF Schema (RDFS), OWL (Web Ontology Language), FOAF (Friend of a Friend ontology), rule sets in RuleML (Rule Markup Language), etc.

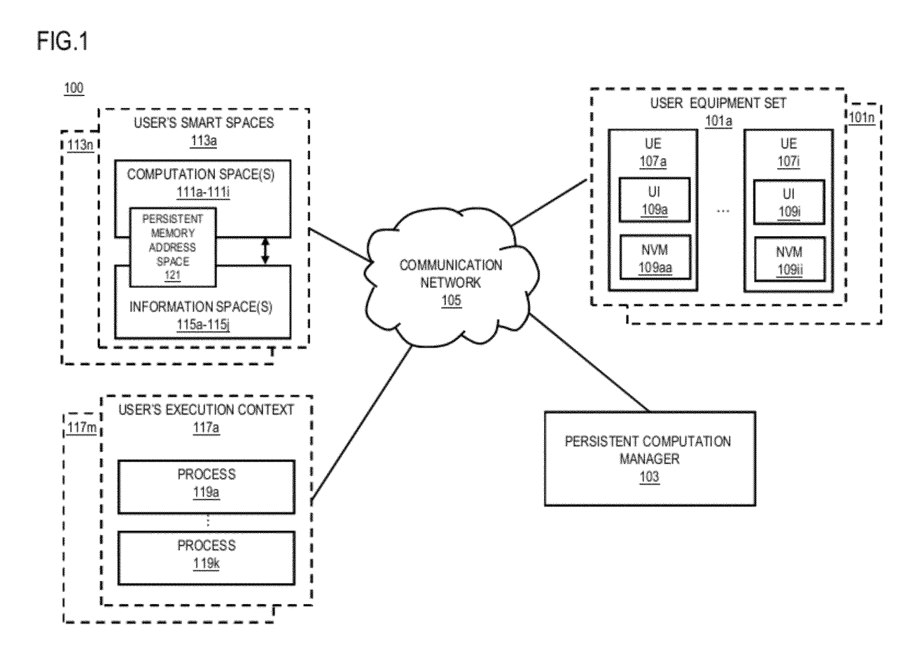

FIG. 1 is a diagram of a system capable of providing persistent computations, according to one embodiment. It is noted that computation spaces as part of smart spaces are an example of distributed computation. The smart spaces are referred to as a sample platform for distributed computation. However, the approach described is applicable in other distributed computation environments.

As previously described, a smart space consists of information and computation spaces each consisting of several distributed devices that communicate information and computation closures (e.g. RDF graphs) via a shared memory. A device within a computation space environment may store computation closures locally in its own memory space or publish computation closures on a globally accessible environment within the smart space. In the first case, the device is responsible for any process needed for combination or extraction of computations, while in the second case the processes can be conducted by the globally accessible environment. However, in many cases, the computation closures may be organized as lists or sets that can include many computation elements (e.g., preliminary computation closures related to a goods inventory operation, a contact list management, etc.).

The basic concept of computation space technology provides access to distributed computations for various devices within the scope of the smart space, in such a way that the distributed nature of the computations is hidden from users and it appears to a user as if all the computations are performed on the same device. The computation space also enables a user to have control over computation distribution by transferring computations between devices that the user has access to. For example, a user may want to transfer computations among work devices, home devices, and portable devices. Current technologies enable a user of a mobile device to manipulate contexts such as data and information via the elements of a user interface of their user equipment. However, a user does not have control over the distribution of computations and processes related to or acting on the data and information within the information space. In other words, an information space in general does not provide a user (e.g., an owner of a collection of information distributed over the information space) with the ability to control distribution of related computations and processes of, for instance, applications acting on the information. For example, a contact management application that processes contact information distributed within one or more information spaces generally executes on a single device (e.g., with all processes and computations of the application also executing on the same device) to operate on the distributed information. In some cases (e.g., when computations are complex, the data set is large, etc.), providing a means to also distribute the related computations in addition to the information space is advantageous.

This goal is achieved by introduction of the capability to construct, distribute, and aggregate computations as well as their related data. More specifically, to enable a user of a smart space, who connects to the smart space via one or more user devices, to distribute computations among the one or more user devices or other devices with access to the information space, each computation is deconstructed to its basic or primitive processes or computation closures. Once a computation is divided into its primitive computation closures, the processes within or represented by each closure may be executed in a distributed fashion and the processing results can be collected and aggregated into the result of the execution of the initial overall computation.

However, the computation closures are typically defined, constructed, and executed within the run-time environments built based on volatile memory technologies, for example Random Access Memory (RAM). Therefore, in any event if the volatile memory loses its power supply before the execution is complete; the execution will be lost and needs to be repeated once the power is restored.

To address this problem, a system 100 of FIG. 1 introduces the capability to provide persistent computations by creating a persistent memory address space utilizing non-volatile memory spaces such as Phase-Change Memory (PCM), Resistive Random Access Memory (ReRAM), etc.

In one embodiment, the persistent memory address space created for computation purposes enables the system to track the computation closures and reduces the need for code exchange between the devices involved in distributed computation. The persistent memory address space may consist of physically disjoint pieces of non-volatile memories distributed among the devices (e.g. user equipments, backend devices, etc.)

As shown in FIG. 1, the system 100 comprises one or more sets 101a-101n of user equipment (UEs) UE 107a-107i, having connectivity to the persistent computation manager 103 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the UEs 107a-107i are respectively equipped with one or more user interfaces (UI) 109a-109i. Each UI 109a-109i may consist of several UI elements (not shown) at any time, depending on the service that is being used. UI elements may be icons representing user contexts such as information (e.g., music information, contact information, video information, etc.), functions (e.g., setup, search, etc.) and/or processes (e.g., download, play, edit, save, etc.). Additionally, each UI element may be bound to a context/process by granular migration. In one embodiment, granular migration enables processes to be implicitly or explicitly migrated between devices, information spaces, and other infrastructure. The process migration can be initiated for example by means of single-cast (e.g., to just another UE 107) or multicast (e.g., to multiple other UEs 107). Additionally, process migration may be triggered via gesture recognition, wherein the user preselects a particular set of UI elements and makes a gesture to simulate “pouring” the selected UE elements from one device to another.

In one embodiment, the UEs 107a-107i are respectively equipped with one or more Non-Volatile Memory spaces (NVM) 109aa-109ii.

As seen in FIG. 1, a user of UEs 107a-107i may own, use, or otherwise have access to various pieces of information distributed over a set 113a of information spaces 115a-115j. In the approach described herein, the information spaces 115a-115j may also be known as a computation space when one or more of the information spaces 115a-115j include one or more computation closures. The user can access the information via the set 101a consisting of UEs 107a-107i wherein each UE 107a-107i is equipped with one or more user interfaces (UI) 109a-109i. Furthermore, each UE 107a-107i may have access to a computation set 117a consisting of processes 119a-119k that can be used to manipulate the information stored in information spaces 115a-115j and produce results requested by the user of the UE 107.

In one embodiment, the persistent computation manager 103 monitors the distribution and execution of the computations 117a-117m and processes 119a-119k for each UE 107a-107i within the non-volatile memory spaces NVMs 109aa-109ii. The decision on whether the execution of an application consisting of a set of distributed computation closures which consist of sets of primitive closures should be stored in a non-volatile memory space, may be made based on parameters such as user account priorities of the user requesting the execution of the application, criticality of the application, etc. For example, the owner of a UE 107a may sign up for a plan that ensures execution of some or all of user's applications in persistent memory space. This service enables the UE 107a to resume execution of the computation closures associated with an application after the execution is interrupted due to, for example, low battery power, or any incident that may erase content of the volatile memory spaces. In one embodiment, the service may provide different levels of availability, priority, types, etc. of computation closures based on the level of the subscribed services. For example, the service may provide for premium (e.g., first class), medium (e.g., business class), ordinary (e.g., economy class) levels of service that have differing levels of, e.g., availability, priority, types, etc. of computation closures for use in various embodiments of the approach described herein. In yet another embodiment, the different levels of service may also provide access to different amounts of non-volatile storage space at the device, the backend, or a combination for storage of computation closures. In one embodiment, the resumption of execution of computation closures in a non-volatile memory allows the execution to resume from the point it was interrupted without information loss. Accounting for different levels of service can provide increased levels of protection against such information loss depending on the needs of the user. Furthermore, utilization of non-volatile memory spaces as part of distributed execution environments for distributed computation closures enables the computations to continue within the smart space environment, even after one or more UEs 107a-107i are inaccessible. For example, while a UE shuts off unexpectedly, the active applications associated with the UE may remain active within the persistent memory space until the UE is back on.

By way of example, the UE 101, and the persistent computation manager 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

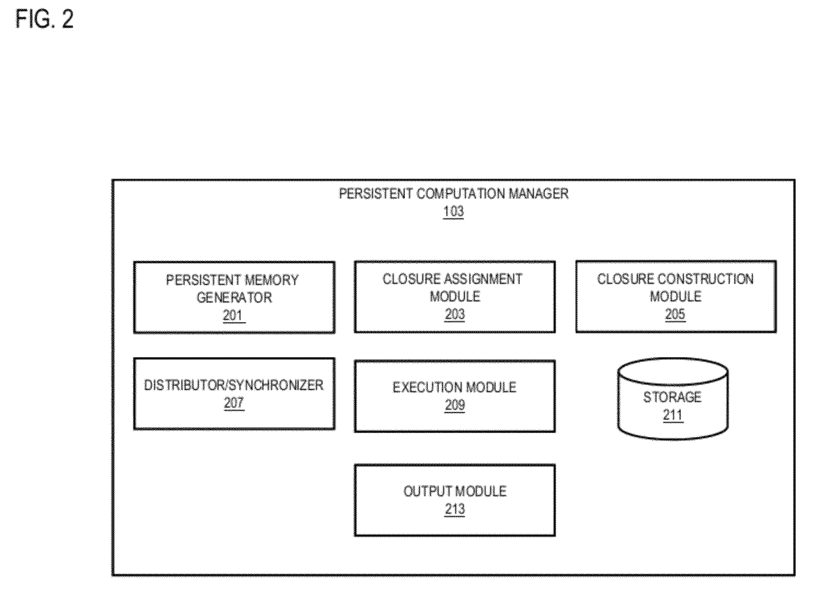

FIG. 2 is a diagram of the components of persistent computation manager, according to one embodiment. By way of example, the persistent computation manager 103 includes one or more components for providing persistent computations. It is contemplated that the functions of these components may be combined in one or more components or performed by other components of equivalent functionality. In this embodiment, the persistent computation manager 103 includes a persistent memory generator 201, a closure assignment module 203, a closure construction module 205, a distributor/synchronizer 207, an execution module 209, and a storage 211.

In one embodiment, the persistent memory generator 201, of the persistent computation manager 103, determines a non-volatile memory space 109aa-109ii of a UE 107a-107i or of a backend device (no shown). The persistent memory generator 201 also determines a non-volatile memory space 109aa-109ii of at least another device 107a-107i or of another backend device. The persistent memory generator 201 then determines to form a persistent memory address space 121 based, at least in part, on the determined non-volatile memory spaces. In one embodiment, the persistent address space 121 includes the determined non-volatile memory spaces 109aa-109ii.

In one embodiment, the closure assignment module 203 determines one or more computation closures of a run-time environment associated with either of the UE 107a-107i or the backend device. The computation closures may be associated with a process related to one or more applications, one or more dependencies of the one or more applications, or a combination thereof for the UE 107a-107i or the backend device. The closure assignment module 203 then stores the one or more computation closures in the persistent memory address space 121 determined by the persistent memory generator 201. For example, the computation closures may be associated with the execution of a GPS application on a mobile device and some of the dependencies of the GPS application may be the database containing the maps data, the modules of the code executed by the application, wherein the modules may be located on the user's smart space 113a-113n, etc.

In one embodiment, the determining to store the one or more computation closures in the persistent memory address space 121 includes determining to construct the one or more computation closures in the persistent memory address space 121. In one embodiment, the closure construction module 205 constructs the one or more computation closures based, at least in part, on a set of computation closure primitives stored in the non-volatile memory space, at least one other set of computation closure primitives stored in the at least one other non-volatile memory space, or a combination thereof.

In one embodiment, the set of computation closure primitives is a subset of the at least one other set of computation closure primitives. For example a UE 107a-107i may have a set of computation closure primitives associated with the applications available on UE 107a-107i. This set of computation closure primitives may be a subset of a superset of computation closure primitives on a persistent memory address space 121 included in the computation space 111a-111i of the smart spaces 113a-113n.

In one embodiment, the subset of the computation closure primitives is determined based, at least in part, on one or more criteria such as time of access, frequency of access, a priority classification, or a combination thereof. For example, the computation closure primitives most recently used may be determined and stored on a non-volatile memory space, while the computation closure primitives that have not been used for more than a certain time threshold may not be expected to be accessed in early future. In some other situations, the computation closure primitives that have been accessed more frequently than others may be selected for being stored on the non-volatile memory space.

In one embodiment, the distributor/synchronizer 207 determines metadata for specifying at least one of the one or more computation closures that are constructed by the closure construction module 205 and stored in the persistent memory address space 121 by the closure assignment module 203. The metadata may accompany the computation closures and provide information for reconstructing the at least one computation closure at the time of execution.

In one embodiment, following the determination of metadata, the distributor/synchronizer 207 determines to perform a distribution, a synchronization, or a combination thereof of at least one of the one or more computation closures between the UE 107a-107i, and the at least one other device (e.g. another UE 107a-107i, backend device, etc.) by determining to distribute, to synchronize, or a combination thereof the metadata. For example, the computation closures may be distributed from a non-volatile memory space on a backend device to a non-volatile memory space on a UE 107a-107i for the UE 107a-107i to be able to locally execute the closures, wherein the non-volatile memory spaces of the backend device and the UE 107a-107i are part of the persistent memory 121 generated by the persistent memory generator 201.

In one embodiment, the execution module 209 determines to retrieve at least one of the one or more computation closures stored in the persistent memory address space 121. The execution module 209 further determines to cause, at least in part, actions resulting in placement of the at least one computation closure in a non-volatile execution memory space 109aa-109ii of the device, the at least one other device, or a combination thereof.

In one embodiment, the persistent computation manager 103 may store the intermediate results of any step of the process such as the determined computation closures, closure primitives, metadata, etc. in the local storage 211. In other embodiments, the local storage 211, or at least a part of it, may be utilized as part of the persistent memory address space 121.

In yet another embodiment, the persistent computation manager 103 may interact with or include an output module 213. In this embodiment, the output module 213 facilitates a creation and/or a modification of at least one device user interface element, at least one device user interface functionality, or a combination thereof based, at least in part, on information, data, messages, and/or signals resulting from any of the processes and or functions of the recommendation platform 103 and/or any of its components or modules. By way of example, a device user interface element can be a display window, a prompt, an icon, and/or any other discrete part of the user interface presented at, for instance, the UE 101. In addition, a device user interface functionality refers to any process, action, task, routine, etc. that supports or is triggered by one or more of the user interface elements. For example, user interface functionality may enable speech to text recognition, haptic feedback, and the like. Moreover, it is contemplated that the output module 213 can operate based at least in part on processes, steps, functions, actions, etc. taken locally (e.g., local with respect to a UE 101) or remotely (e.g., over another component of the communication network 105 or other means of connectivity).

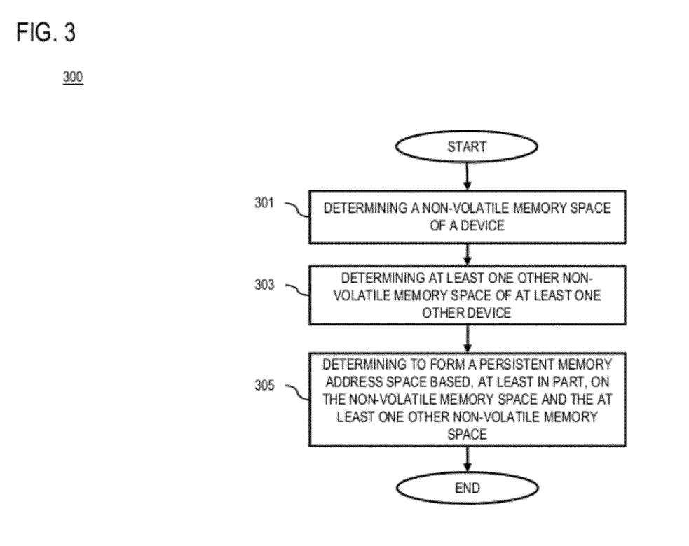

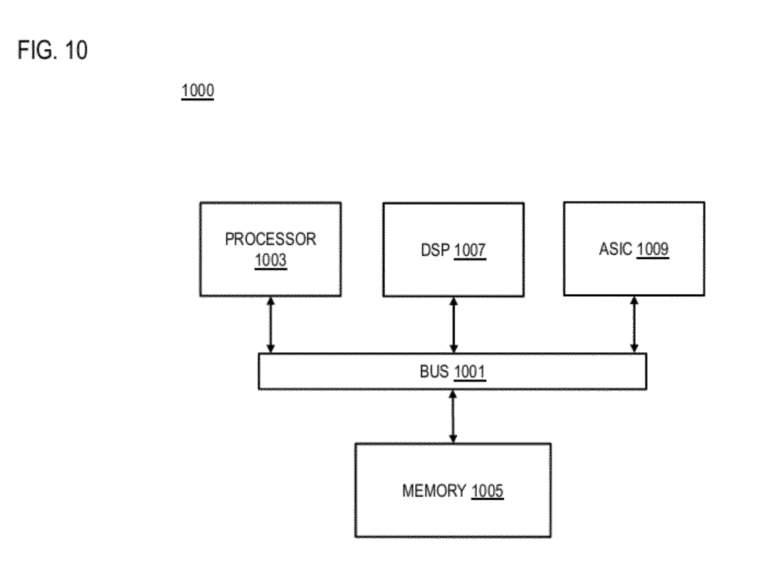

FIG. 3 is a flowchart of a process for providing persistent computations, according to one embodiment. In one embodiment, the persistent computation manager 103 performs the process 300 and is implemented in, for instance, a chip set including a processor and a memory as shown in FIG. 10. In step 301, the persistent memory generator 201 determines a non-volatile memory space of a device. The determined non-volatile memory space may be the memory space 109aa-109ii from device 107a-107i, or a non-volatile memory space in a backend device (not shown) having connectivity to the persistent computation manager 103 via the communication network 105. In step 303, the persistent memory generator 201 determines at least one other non-volatile memory space of at least another device. The determined non-volatile memory space may be the memory space 109aa-109ii from device 107a-107i, or a non-volatile memory space in a backend device (not shown) having connectivity to the persistent computation manager 103 via the communication network 105. The determined non-volatile memory spaces which are distributed chunks of non-volatile memory may be formed into a single address space 121 which is persistent because it is made of non-volatile memory spaces. In step 305 the persistent memory generator 201 determines to form the persistent memory address space 121 based on the determined non-volatile memory spaces.

In one embodiment, determining a non-volatile memory space may include determining the starting and ending addresses (or starting address and volume) of available non-volatile memory spaces. Similarly, determining to form a persistent memory address space 121 may include generating address links among the determined non-volatile memory spaces so that the distributed pieces of non-volatile memory spaces can be treated as a continuous persistent address space. The determined non-volatile memory spaces may be considered as parts of the user's smart spaces 113a-113n (e.g. within the computation spaces 111a-111i).

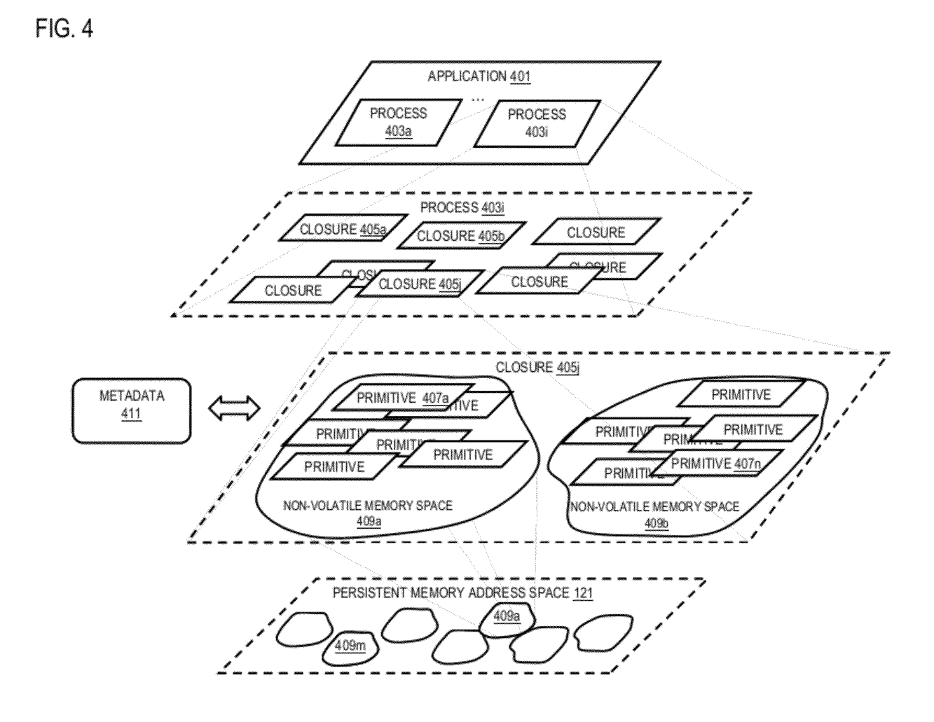

FIG. 4 is a diagram of relation between processes, computation closures and closure primitives, according to one embodiment. As seen in FIG. 4 an application 401 consists of multiple processes 403a-403i. In order to provide distributed computation services to the users of user equipment sets 101a-101n, each process 403a-403i is divided into a set of computation closures 405a-405j which basically are stand alone computational components and can be executed independently from each other. Dividing a process 403a-403i into computation closures 405a-405j allows creation of distributed computation spaces 111a-111i that together with information spaces 115a-115a provide distributed computation services to the users.

Furthermore, each computation closure 405a-405j may be further divided into a set of closure primitives 407a-407n. Closure primitives can be considered as the building blocks of closures 405a-405j which may not get divided any further. Creation of primitive closures 407a-407n provides the possibility of reusing and recycling the closure primitives 407a-407n in constructing computation closures 405a-405j.

In one embodiment, the persistent computation manager 103 determines non-volatile memory spaces 409a-409m, wherein the non-volatile memory spaces 409a-409m may each be located in different devices. The persistent computation manager 103 forms a persistent memory address space 121 that includes all the determined non-volatile memory spaces 409a-409m. As seen in FIG. 4 computation closure 405j is made of closure primitives 407a-407n wherein the primitives are stored in non-volatile memory spaces 409a and 409b.

In one embodiment, the distributor/synchronizer 207 generates metadata 411, wherein the metadata 411 provides information for reconstruction of closure 405j from primitives 407a-407n.

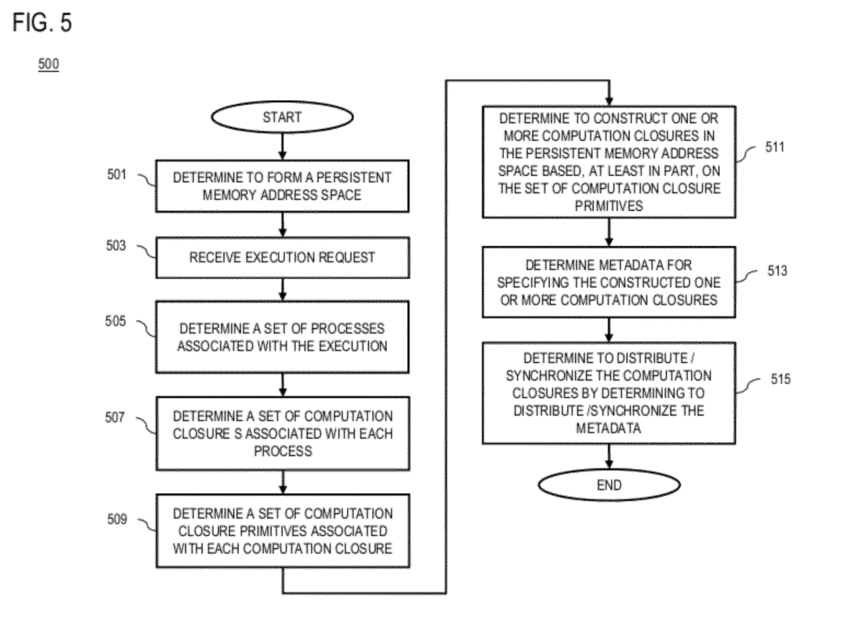

FIG. 5 is a flowchart of a process for constructing a persistent memory address space, according to one embodiment. In one embodiment, the persistent computation manager 103 performs the process 500 and is implemented in, for instance, a chip set including a processor and a memory as shown in FIG. 10. FIG. 5 is described with respect to FIGS. 3 and 4. In step 501, the persistent memory generator 201 determines to form a persistent memory address space 121 as described in FIG. 3. As per step 503 the persistent computation manager 103 receives an execution request, for example, for application 401 associated with the devices which access to the formed persistent memory address space 121. In step 505, the persistent computation manager 103 determines a set of processes 403a-403i associated with application 401. The processes 403a-403i may be provided by one or more other components (not shown) and the persistent computation manager 103 may obtain processes 403a-403i from the one or more other components.

In step 507, the closure assignment module 203 determines a set of computation closures 405a-403j associated with each process 403a-403i. In step 509, the closure assignment module 203 determines to obtain a set of computation closure primitives 407a-407n associated with each computation closure 405a-405j related to processes 403a-403i.

In one embodiment, per step 511, the closure construction module 205 utilizes the closure primitives 407a-407n to construct the computation closure 405j in non-volatile memory spaces 409a and 409b. The distributed nature of non-volatile memory spaces 409a-409m of the persistent memory address space 121 may require extra information (metadata) to be assigned to the sets of closure primitives 407a-407n, in order to associate each set of closure primitives 407a-407n from non-volatile memory spaces 409a-409m to one or more computation closures 405a-405j. Per step 513 the distributor/synchronized 207 determines metadata 411 and associates the metadata 411 with one or more computation closures 405a-405j per step 515.

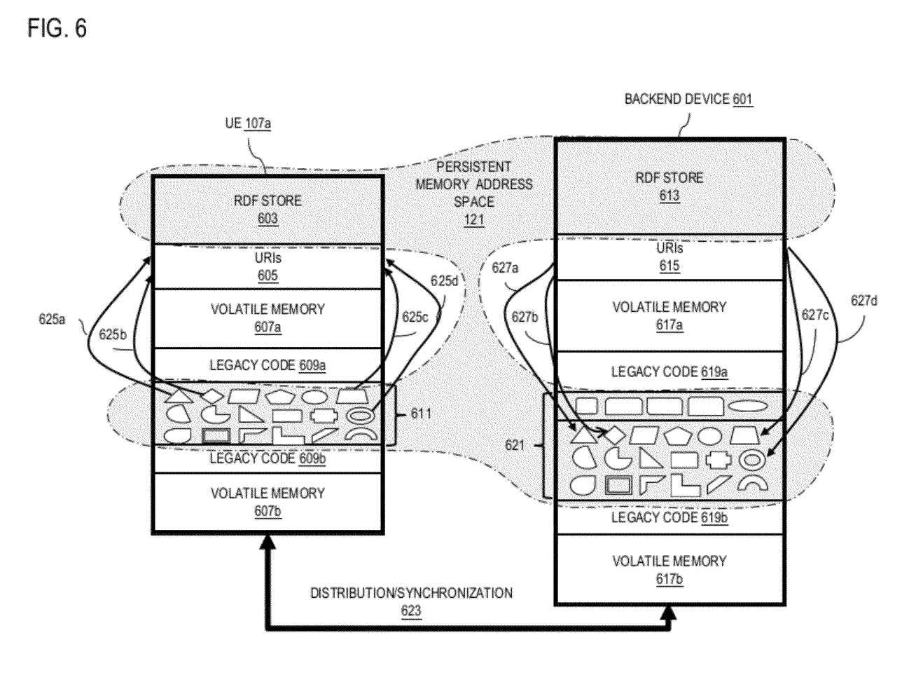

FIG. 6 is a diagram of persistent memory address space among devices, according to one embodiment. The diagram of FIG. 6 shows a persistent memory address space 121 formed between a UE 107a as a client and the backend device 601 as a server. Each of the devices 107a and 601 may include various types of volatile and non-volatile memory spaces. For example, the devices 107a and 601 may have volatile memory spaces (e.g. RAM) 607a and 617a.

In one embodiment, the UE 107a may include RDF store 603, which holds RDF graphs associated with smart spaces 113a-113n related to the UE 107a. Similarly the backend device 601 may includes a RDF store 613, which holds RDF graphs associated with smart spaces 113a-113n related to the backend device 601. A RDF store may be stored in a non-volatile memory space.

In other embodiments, the Uniform Resource Identifiers (URIs) 605 in UE 107a and 615 in backend device 601 may be used to identify names or resources accessible to their respective devices via the communication network 105. Furthermore, the legacy codes associated with each device may be stored in legacy code memory areas 609a and 609b on UE 107a and 619a and 619b on backend device 601. The URIs and legacy codes are stored on non-volatile memory spaces.

In one embodiment, UE 107a may be provided with a non-volatile memory space 611 as a closure store. The closure store 611 may include a set of closure primitives shown as geometric objects, similar to primitives 407a-407n in FIG. 4. Similarly, the backend device 601 may be provided with a non-volatile memory space 621 as a closure store. The closure store 621 may also include a set of closure primitives shown as geometric objects. In one embodiment, the closure store 611 is a subset of closure store 621 determined, at least in part, based on one or more criteria such as time of access, frequency of access, a priority classification, etc. Since non-volatile memories are costly and require extensive resources (e.g. power consumption) compared with volatile memories, the capacity of non-volatile memory on a UE 107a-107i is limited. However, a backend device 601, serving high numbers of users, may be equipped with larger volumes of non-volatile memory spaces. Because of the limited capacity of non-volatile memory spaces on UEs 107a-107i, a subset of the closure store 621 is stored locally at the closure store 611 for local use by the UE 107a. In order to minimize the number of times a UE 107 needs to retrieve one or more primitives from closure store 621 of device 601, the subset 611 is determined based on one or more criteria. In one embodiment, the distributor/synchronizer 207 determines the closure store 611 as a set of the most frequently accessed closure primitives of closure store 621 by UE 107a. In another embodiment, the distributor/synchronizer 207 may determine the closure store 611 as a set of the most recently accessed closure primitives of closure store 621 by UE 107a. In other embodiments, various combined conditions and criteria may be used by the distributor/synchronizer 207 for determining subset 611 from set 621 as the content of closure store for UE 107a. Furthermore, the distributor/synchronizer 207 may maintain the closure stores 611 and 621 synchronized (shown as arrow 623). The synchronization of closure stores ensures that any changes (addition, deletion, modification, etc.) in closure primitives of closure store 621 are reflected in the closure store 611.

In one embodiment, for execution of each process 493a-403i associated with UE 107a, the execution module 209 may select a subset of primitives from closures store 611 and stores them on URIs 605 (shown by arrows 625a-625d). The execution module 209 may then inform the processing components of the UE 107a, the backend device 601 or a combination thereof (the processing components are not shown), that the closure primitives are ready for execution.

In one embodiment, any changes on the closure store 621 of the backend device 601 (e.g., addition, deletion, modification, etc.) may first enter the URIs 615 via the communication network 105. The changes may then be applied from URIs 615 on closure store 621 shown by arrows 627a-627d.

In one embodiment, as seen in FIG. 6, the persistent computation manager 103 forms the persistent memory address space 121 from the RDF stores 603 and 613 and the closure stores 611 and 621. The persistent memory address space 121 can be accessed as a continuous memory space by each of the devices 107a and 601. This approach enables the backend device 601 to continue an ongoing execution of a process for UE 107a even when UE 107 is shut off due to any incident such as low battery. For example, if UE 107a shuts off while processing a map or searching for an address on the map, the search may continue on the backend and once the UE 107a is back on, the search results may be presented to the user. Therefore, the UE 107 shutting off will not interrupt the ongoing processes.

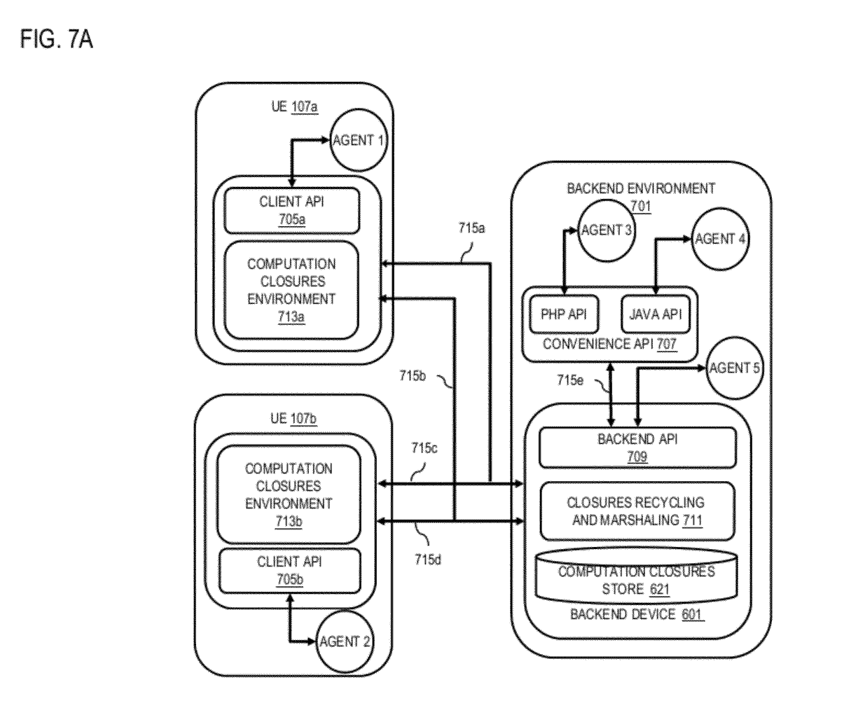

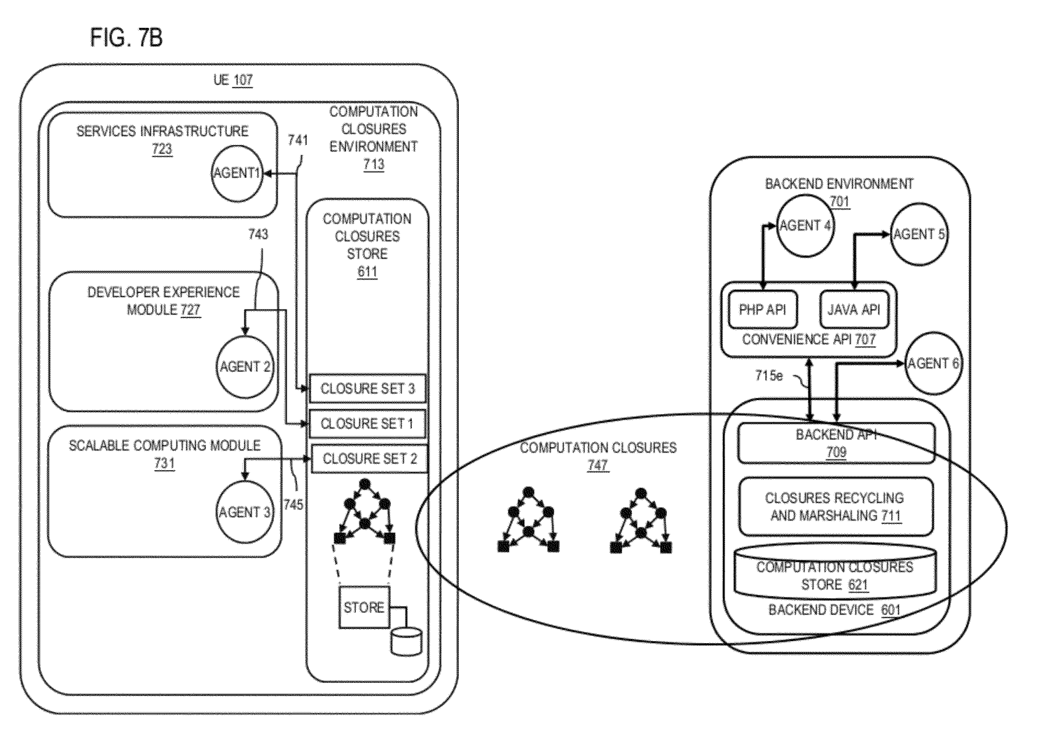

FIGS. 7A-7B are diagrams of computations recycling among devices, according to one embodiment. In one embodiment, in FIG. 7A, the backend environment 701 may be a virtual run-time environment within the user's smart spaces 113a-113n or on one UE 107 associated with the user. The backend environment 701 may include one or more backend devices 601 and one or more Application Programming Interface (API) such as a convenience API 707 that may include APIs tailored to the software development environments used (e.g. JAVA, PHP, etc.). Each API enables interaction between devices and components within the backend environment 701. For example, backend API 709 enables interaction between the backend device 601 and Agent5, and convenience API 707 enables interaction between the backend device 601 and agents Agent3 and Agent4, wherein each agent is a set of processes that handle computation closures within the backend environment 701. As seen in the example of FIG. 7A, Agent3 works under PHP while Agent4 is a JAVA process. Similarly, each of the UEs 107a and 107b has at least a respective Agent 1 and Agent 2 which interact with computation closure environments 713a and 713b through, for instance, client APIs 705a and 705b which are part of, for instance, computation spaces 111a-111i. Arrows 715a-715e represent distribution of computation closures among the environments 713a, 713b and the computation closure store 621. The computation closures store 621 is a repository of computation closures that can be accessed and used by all the UEs having connectivity to the backend environment 701.

In one embodiment, the backend device 601 may be equipped with a closure recycling and marshaling component 711 that monitors and manages any access to the computation closure store 621. In other embodiments the closure recycling and marshaling (i.e. standardization for uniform use) may be a function of the persistent computation manager 103.

In one embodiment, the computation closures within environments 713a, 713b and the computation closures store 621 may be composed based on anonymous function objects and automatically created by a compiling system using methods for generating anonymous function objects such as lambda expressions.

FIG. 7B is an expanded view of a computation closure environment 713 as introduced in FIG. 7A. The computation closure environment 713 may be composed of one or more computation closure generating components. In one embodiment the computation closure environment 713 has a services infrastructure 723 that provides various services for the user of the UE 107. The services may include any application that can be performed on the UE 107 such as, games, music, text messaging, voice calls, etc. In one embodiment, the service infrastructure 723 provides support for closure based granular reflective processes under the supervision of a persistent computation manager 103 as discussed in FIG. 1. The agent Agent1 retrieves the computation closures required by the services infrastructure 723 from the computation closures store 611 and stores the newly generated computation closures by the services infrastructure 723 into the computation closures store 611 for recycling purposes per arrow 741.

In another embodiment, the computation closure environment 713 has a developer experience module 727 that provides various tools for a developer for manipulating services offered by the UE 107. The tools may include standardized and/or abstract data types and services allowing the developers to chain processes together across development platforms. In one embodiment, the developer experience module 727 provides cross platform support for abstract data types and services under the supervision of a persistent computation manager 103 as discussed in FIG. 1. The agent Agent2 retrieves the computation closures required by the developer experience module 727 from the computation closures store 611 and stores the newly generated computation closures by the developer experience module 727 into the computation closures store 611 for recycling purposes per arrow 743.

In yet another embodiment, the computation closure environment 713 has a scalable computing module 731 that provides an abstract wrapper (i.e. monadic wrapper) for the execution context 117. This abstraction provides computation compatibility between the execution context 117 and the UE 107. The abstract wrapper may provide scheduling, memory management, system calls and other services for various processes associated with the execution context 117. These services are provided under the supervision of the persistent computation manager 103 as discussed in FIG. 1. The agent Agent3 retrieves the computation closures required by the scalable computing module 731 from the computation closures store 611 and stores the newly generated computation closures by the scalable computing module 731 into the computation closures store 611 for recycling purposes per arrow 745. In one embodiment, the backend environment 701 may access the computation closure store 611 and exchange one or more computer closures 747 between the computation closures store 611 and the backend computation closures store 621.

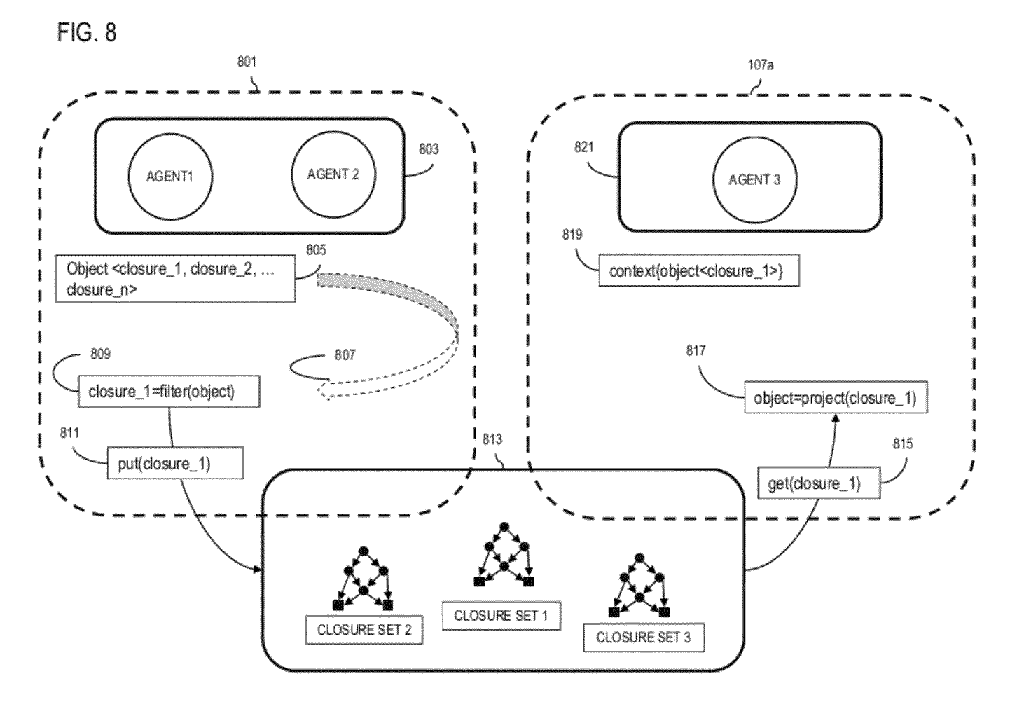

FIG. 8 is a diagram of process migration from a device to another device, according to one embodiment. In one embodiment, the backend device 801 may be a virtual run-time environment within the user's smart spaces 113a-113n or on one UE 107 associated with the user. The backend device 801 may include a user context 803 for every user equipment 107a-107i connected to the backend device 801. The user context 803 may be a copy of the user context 821 for each device 107a which is being migrated among devices. Agent1 and agent2 are processors that calculate and handle computation closures within the user context 803. The number of agents may be different in different devices based on their design, functionality, processing power, etc. Block 805 represents an Object as a set of computation closures, closure_1, closure_2, . . . , and closure_n, where each closure is a component of a larger process, for example, related to a service provided to the user by the user equipment 107a. The closures may be generated by a component of the closure construction module 205 and each closure is a standalone process that can be executed independently from the other closures. In the example of FIG. 8, the filtering process 807 extracts closure_1 from the closure set Object via filtering the set (shown in block 809) by a component of the closure construction module 205. The extracted closure_1 is added to a computation closure store 813 using the exemplary Put command 811.

In this example, assuming that the extracted computation closure, closure_1 is supposed to be executed on the user equipment 107a, the user equipment 107a extracts the computation closure closure_1 from the computation closure store 813 using the Get command 815.

In one embodiment, the decision of the equipment on which a computation closure is executed, may be made by a user by pushing, or flicking specific icons of the user interface associated with a process on one user equipment towards another user equipment (e.g. 107a). In another embodiment, the equipment executing a computation closure may be automatically assigned. The extracted closure_1 is projected into a closure with the user device context (process states) and the object 817 is produced. The block 819 represents the reconstruction of the closure into the initial context by a component of the closure construction module 205. The aggregated context may then be executed in the run-time environment 821 of UE 107b by Agent3.

In another embodiment, the block 801 may be a user equipment and block 107a a backend device or both blocks 801 and 107a may be UEs. In this embodiment the decomposition and aggregation processes are similar to the above example with the difference that closure_1 is extracted from a process on the UE 801.

The processes described herein for providing persistent computations may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

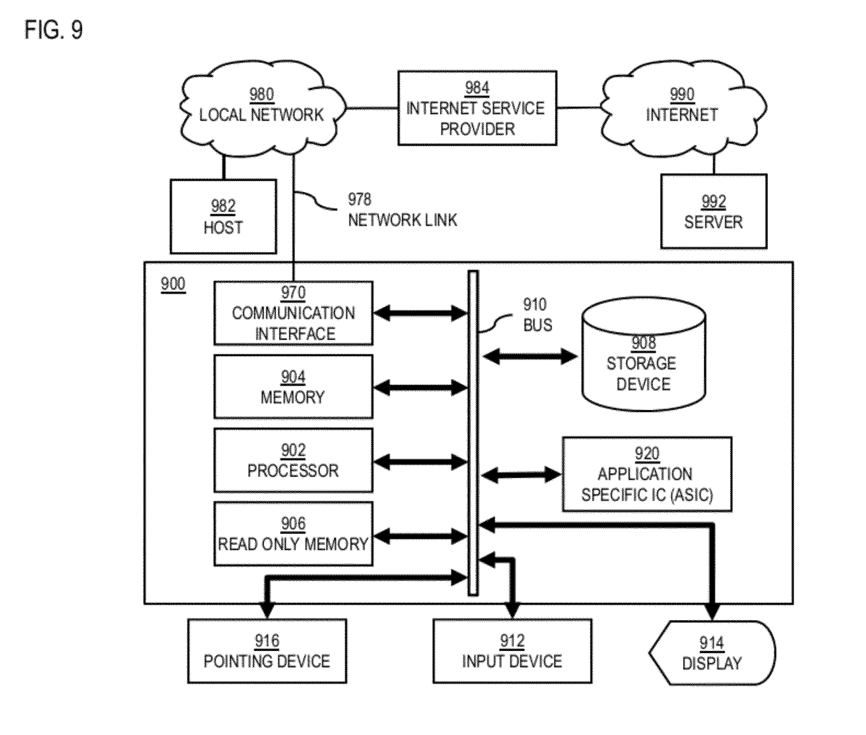

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide persistent computations as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing persistent computations.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing persistent computations. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing persistent computations. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing persistent computations, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for the persistent computation manager 103 to the UEs 107a-107i 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide persistent computations as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing persistent computations.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide persistent computations. The memory 1005 also stores the data associated with or generated by the execution of the inventive steps.

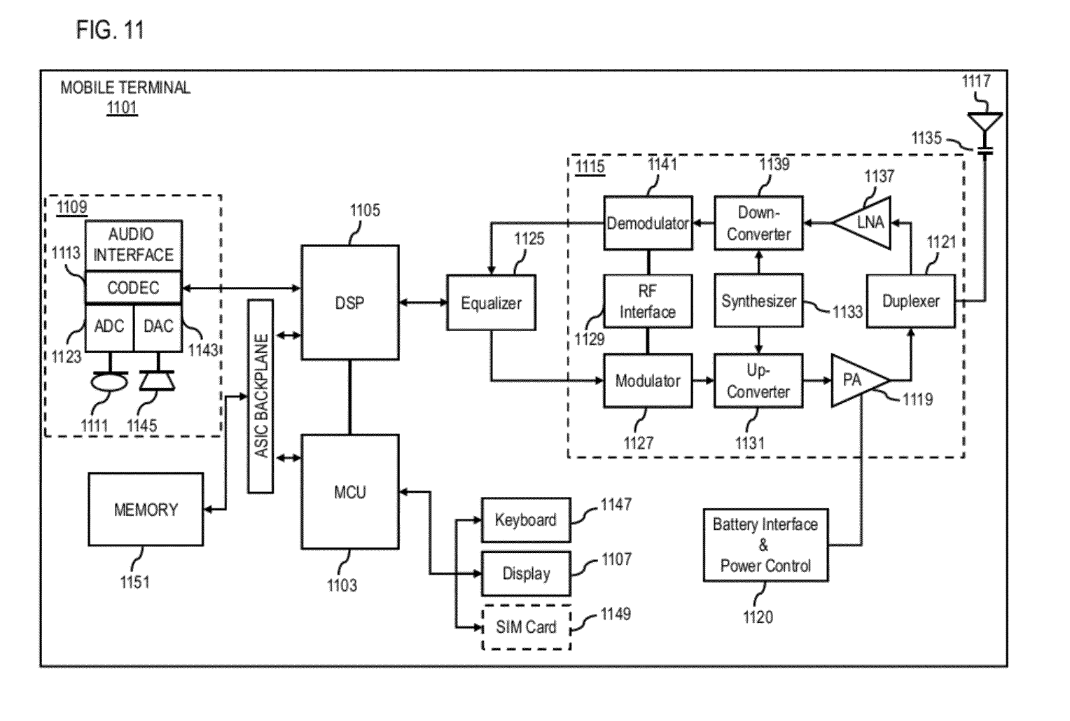

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing persistent computations. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing persistent computations. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide persistent computations. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one non-volatile memory space of a device;
at least one other non-volatile memory space of at least one other device; and
at least one determination to form a persistent memory address space based, at least in part, on the at least one non-volatile memory space and the at least one other non-volatile memory space.

2. A method of claim 1, wherein the (1) data and/or (2) information and/or (3) at least one signal are further based, at least in part, on the following:
one or more computation closures of a run-time environment associated with the device; and
at least one determination to store the one or more computation closures in the persistent memory address space.

3. A method of claim 2, wherein the at least one determination to store the one or more computation closures comprises:
at least one determination to construct the one or more computation closures in the persistent memory address space based, at least in part, on a set of computation closure primitives stored in the at least one non-volatile memory space, at least one other set of computation closure primitives stored in the at least one other non-volatile memory space, or a combination thereof.

4. A method of claim 3, wherein the set of computation closure primitives is a subset of the at least one other set of computation closure primitives.

5. A method of claim 4, wherein the (1) data and/or (2) information and/or (3) at least one signal are further based, at least in part, on the following:
at least one determination of the subset based, at least in part, on one or more criteria.

6. A method of claim 5, wherein the one or more criteria include a time of access, a frequency of access, a priority classification, or a combination.

7. A method of claim 2, wherein the (1) data and/or (2) information and/or (3) at least one signal are further based, at least in part, on the following:
metadata for specifying at least one of the one or more computation closures, the metadata providing information for reconstructing the at least one computation closure; and
at least one determination to perform a distribution, a synchronization, or a combination thereof of at least one of the one or more computation closures between the device and the at least one other device by determining to distribute, to synchronize, or a combination thereof the metadata.

8. A method of claim 2, wherein the one or more computation closures represent one or more applications, one or more dependencies of the one or more applications, or a combination thereof.

9. A method of claim 1, wherein the (1) data and/or (2) information and/or (3) at least one signal are further based, at least in part, on the following:
at least one of the one or more computation closures from the persistent memory address space; and
at least one determination to cause, at least in part, actions for resulting in placement of the at least one computation closure in a non-volatile execution memory space of the device, the at least one other device, or a combination thereof.

10. A method of claim 1, wherein the device is a client of the at least one other device.

11. An apparatus comprising:
at least one processor; and
at least one memory including computer program code for one or more programs,
the at least one memory and the computer program code configured to, with the at least one processor, cause the apparatus to perform at least the following,
determine at least one non-volatile memory space of a device;
determine at least one other non-volatile memory space of at least one other device; and
determine to form a persistent memory address space based, at least in part, on the at least one non-volatile memory space and the at least one other non-volatile memory space.

12. An apparatus of claim 11, wherein the apparatus is further caused to:
determine one or more computation closures of a run-time environment associated with the device; and
determine to store the one or more computation closures in the persistent memory address space.

13. An apparatus of claim 12, wherein the determining to store the one or more computation closures causes the apparatus to:
determine to construct the one or more computation closures in the persistent memory address space based, at least in part, on a set of computation closure primitives stored in the at least one non-volatile memory space, at least one other set of computation closure primitives stored in the at least one other non-volatile memory space, or a combination thereof.

14. An apparatus of claim 13, wherein the set of computation closure primitives is a subset of the at least one other set of computation closure primitives.

15. An apparatus of claim 14, wherein the apparatus is further caused to:
determine the subset based, at least in part, on one or more criteria.

16. An apparatus of claim 15, wherein the one or more criteria include a time of access, a frequency of access, a priority classification, or a combination.

17. An apparatus of claim 12, wherein the apparatus is further caused to:
determine metadata for specifying at least one of the one or more computation closures, the metadata providing information for reconstructing the at least one computation closure; and
determine to perform a distribution, a synchronization, or a combination thereof of at least one of the one or more computation closures between the device and the at least one other device by determining to distribute, to synchronize, or a combination thereof the metadata.

18. An apparatus of claim 12, wherein the one or more computation closures represent one or more applications, one or more dependencies of the one or more applications, or a combination thereof.

19. An apparatus of claim 11, wherein the apparatus is further caused to:
determine to retrieve at least one of the one or more computation closures from the persistent memory address space; and
determine to cause, at least in part, actions for resulting in placement of the at least one computation closure in a non-volatile execution memory space of the device, the at least one other device, or a combination thereof.

20. An apparatus of claim 11, wherein the device is a client of the at least one other device.

21.-49. (canceled)
